(19) United States
(12) Patent Application Publication
(10) Pub. No.: US 2026/0084256 A1
(43) Pub. Date: Mar. 26, 2026

(54) COOLANT DELIVERY HEAD FOR WHIRLING AND METHODS

(71) Applicant: MOUNT MFG, LLC, Marquette, MI (US)

(72) Inventors: Jesse John Nye, Negaunee, MI (US); Nicholas Hamel, Skandia, MI (US); Tyles Thomas Kerkela, Marquette, MI (US)

(73) Assignee: MOUNT MFG, LLC, Marquette, MI (US)

(21) Appl. No.: 18/893,591

(22) Filed: Sep. 23, 2024

(51) Int. Cl. B23Q 11/12; B23B 5/00; B23G 5/00

(52) U.S. Cl. CPC B23Q 11/126; B23B 5/00; B23B 2270/30; B23G 5/005

(57) ABSTRACT

A coolant delivery head for whirling material stock. The coolant delivery head comprising a one-piece plate like structure sized to fit between the guide bushing and whirling unit of a CNC Swiss turning machine. The coolant delivery head comprises an intake port to receive high pressure coolant through a coolant supply line. Coolant channels internal to the delivery head body, channel the coolant to a first and second delivery port and a blow port. The delivery ports are angled to deliver coolant directly at cutter inserts in the whirling unit during operation. The blow port blows coolant towards the tailstock of the machine. The coolant delivery head comprises one or more fastener holes for receiving fasteners to secure the coolant delivery head to a whirling unit. Precise delivery of the coolant results in higher quality machined products and less tool wear.

This application is a Non-Provisional Patent Application.

### BACKGROUND OF THE INVENTION

Field of the Invention. The invention relates generally to coolant spray devices, and more particularly to precise high-pressure coolant delivery during CNC thread whirling.

### Description of Related Art

The industry standard method for delivering coolant during machining is to use a single metallic tube that is bent to shape and aimed at the flight circle of the whirling unit. Traditionally whirling machines use a coolant pipe system that sprays coolant backwards towards the CNC machine's guide bushing and as a result, the cutting chips pack into the 3 slots in the guide bushing. This is problematic as it will cause the guide bushing to seize and can introduce wobble or adjustment issues during the machining process that causes dimensional tolerancing problems in the product. Many of the metal machining chips will get pushed through the guide bushing and end up in the headstock cabinet where the bar feeder is. In addition, the bar feeder utilizes a hydraulic oil and not a coolant. Because of the coolant spraying toward the guide bushing, the coolant can travel along the bar, into the bar feeder, and mix with the hydraulic oil in the bar feeder. This will contaminate the bar feeder hydraulic oil and furthermore will cause the bar feeder's oil sump to overflow.

What is needed is a coolant delivery mechanism that has a narrow profile beneficial for fit in tight spaces behind a whirling unit. What is needed is a coolant delivery mechanism that delivers high pressure coolant directly at the interface between the cutter insert and machined material and pushes machining chips away from the guide bushing instead of towards it. What is needed is a coolant delivery mechanism that performs these functions without repeated adjustment of the coolant spray direction. What is needed is a coolant delivery mechanism that flushes chips away from the guide bushing.

### SUMMARY OF THE INVENTION

In one form, a coolant delivery head is bolted to a whirling unit.

In one form, the whirling unit comprises a whirling ring.

In one form, spaced about the whirling ring are a plurality of cutter inserts.

In one form, a coolant delivery head is coupled to a high pressure coolant supply.

In one form, the coolant delivery head has an internal passage that connects the coolant supply to a plurality of delivery and blow ports which can include a spray nozzle.

In one form, the coolant delivery head is mounted to a housing of the whirling unit which provides precise and repeatable aiming of the coolant.

In one form, delivery ports/nozzles in the coolant delivery head are positioned at precise angles and trajectory to direct coolant at the cutting edge of a whirling insert.

In one form, the coolant delivery head directs coolant between the whirling inserts to flush machined chips out of a whirling ring.

In one form, the coolant delivery head provides precise and repeatable coolant delivery to whirling cutting tips.

In one form, the coolant delivery head directs chips away from the guide bushing in a whirling machine which prevents the guide bushing from becoming packed with whirling chips.

In one form, the coolant delivery head prevents downtime due to issues such as whirling chips clogging the guide bushing or causing wobble during cutting.

In one form, the coolant delivery head prevents chips from entering the headstock cabinet of a Swiss-lathe.

In one form, the coolant delivery head prevents coolant from traveling down the bar stock to the bar feeder.

In one form, the coolant delivery head improves the life of tooling and surface finish of the part produced.

In one form, the coolant delivery head allows the whirling unit to be removed and re-installed quickly without having to re-align the coolant tubes as typical in prior art methods.

In one form, a coolant tube is bent and positioned to fit inside the whirling unit.

In one form, cutter inserts are spaced about a whirling ring of a whirling unit and positioned to cut a bone thread profile. To maximize cutter life, coolant is applied to the cutting edge of the insert at the site where it contacts the material to be machined.

In one form, the CNC lathe has minimal clearance between the guide bushing and the whirling unit consequently limiting the space in which a spray head can operate.

In one form, spray nozzles and/or the coolant delivery ports themselves are aimed to direct coolant at high pressure to the cutting surface from 2 different directions. A third nozzle/spray port (also known as a blow port), blows the coolant straight backwards towards the sub-spindle thereby blowing the chip fragments in the opposite direction (away from the guide bushing). This eliminates coolant from moving toward the guide bushing, and consequently eliminates movement of chip fragments into the guide bushing.

In one form, a coolant supply line connects from a high pressure coolant supply to supply the coolant delivery head.

In one form, the spray nozzles and/or coolant delivery ports are directed to spray precisely on the insert cutting tips, thereby preventing chatter on the threads and premature wear of the cutter inserts.

In one form, the spray nozzles of the coolant delivery head are positioned such that when secured by fixed mounting fasteners to the whirling unit, the spray nozzles are aligned at the insert cutting tips. Typically, visual obstructions limit one's ability to see if the spray is properly aligned. However, this self-aligning feature eliminates the random spraying of coolant.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a perspective view of a common CNC Swiss turning machine used for whirling;

FIG. 2 depicts internal components of the common CNC Swiss turning machine of FIG. 1 further depicting a whirling unit;

FIG. 3 depicts a close up view of the whirling unit of FIG. 2;

FIG. 4 depicts a close-up view of a guide bushing in the CNC Swiss turning machine of FIG. 1;

FIG. 5 depicts a perspective view of a coolant delivery head with fasteners and coolant fittings;

FIG. 6 depicts an alternative perspective view of the coolant delivery head with fasteners and coolant fitting of FIG. 5;

FIG. 7 depicts the coolant delivery head of FIG. 5 with flexible coolant hose attached;

FIG. 8 depicts a front view of a coolant delivery head and depicts an internal coolant channel;

FIG. 9 depicts a rear view of the coolant delivery head of FIG. 8;

FIG. 10 depicts a cross-sectional view through plane A of the coolant delivery head of FIG. 8;

FIG. 11 depicts a bottom perspective view of the coolant delivery head of FIG. 8;

FIG. 12 depicts another bottom perspective view of the coolant delivery head of FIG. 8;

FIG. 13 depicts an end perspective view of the coolant delivery head of FIG. 8;

FIG. 14 depicts an opposing end perspective view of the coolant delivery head of FIG. 8;

FIG. 15 depicts a perspective view of a coolant delivery head mated to a portion of a whirling unit.

### DETAILED DESCRIPTION OF SELECTED EMBODIMENTS OF THE INVENTION

Select embodiments of the invention will now be described with reference to the Figures. Like numerals indicate like or corresponding elements throughout the several views. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

Swiss turning machines are used throughout the world to provide a CNC (computer numerical controlled) machining process that uses a sliding headstock designed to produce small and complex parts. A Swiss-type lathe is a variety of turning machine that feeds the stock through a guide bushing and therefore the turning tool can always cut the stock near the bushing, and therefore near the point of support, no matter how long the workpiece.

Whirling machining is a manufacturing process that uses a whirling ring with cutter inserts to remove material from a workpiece that rotates slowly. The ring rotates at high speed around the workpiece, creating a cutting motion. The whirling ring is positioned within a whirling unit which rotates the whirling ring. Spaced about the perimeter of the ring are cutter inserts positioned to cut a profile into the material such as a bone thread profile. During this operation, directing coolant to the cutting edge of the insert where it contacts the material results in higher quality parts and reduced tool wear.

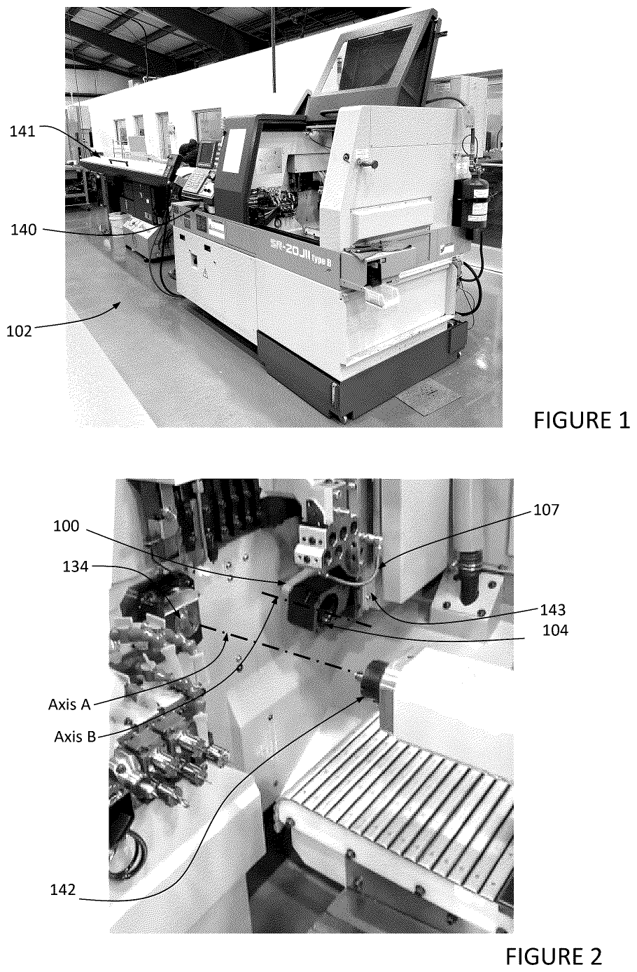

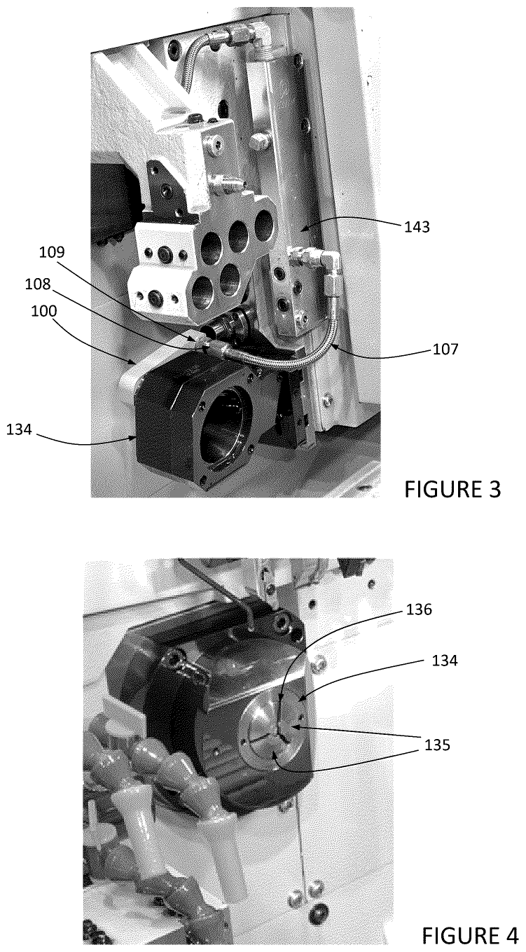

FIG. 1 depicts one type of CNC Swiss turning machine 102. The machine includes a bar feeder 141 that feeds elongate bar stock material into a headstock cabinet 140 where a guide bushing 134 delivers the material into a whirling unit 104. Here, the whirling unit is retracted and thus misaligned with Axis A. During an operational mode, the whirling unit is repositioned such that the whirling unit axis (axis B) is aligned with operational axis (axis A) extending between the guide bushing 134 and tailstock 142.

As noted in the Figures, a coolant delivery head 100 is bolted to a posterior aspect of whirling unit 104 via one or more fasteners (i.e. first fastener 137, second fastener 138). In preferred embodiments, the coolant delivery head is secured at an elevated position on the whirling unit with the intake port 132 unblocked by the whirling unit on a lateral side. As depicted in FIG. 15, a whirling ring 105 is positioned within the whirling unit 104 (only a portion of the whirling unit is shown). Spaced about whirling ring 105 are a plurality of cutter inserts 106 that engage and cut the stock of material to be machined. During this machining operation, a coolant delivery head 100 delivers high pressure coolant to the cutter inserts where they engage the stock material. The coolant delivery head 100 is coupled to a high pressure coolant supply 143 using a coolant supply line 107 therebetween. In this embodiment, the coolant supply line is a flexible braided stainless steel.

Coolant delivery head 100 has an internal passage that connects the coolant supply to delivery ports. Again, coolant delivery head 100 is mounted to the housing of the whirling unit 104 which provides precise and repeatable aiming of the coolant spraying from delivery ports (first delivery port 129, second delivery port 130, blow port 131) from which the coolant can flow. In some cases, spray nozzles 133 are used at the end of the delivery port to further direct the flow of coolant or adjust the spray pattern. However, in preferred embodiment the delivery and blow ports in the coolant delivery head 100 are positioned at precise angles and trajectory to direct coolant at the cutting edge of a cutter insert 106. In some embodiments, the delivery and blow ports in coolant delivery head 100 directs coolant between the cutter inserts to flush machined chips out of whirling ring 105. From this positional relationship, coolant delivery head 100 provides precise and repeatable coolant delivery to cutter inserts 106 while also directing machining chips away from guide bushing 134 which prevents the guide bushing from becoming packed with whirling chips. If the machining chips enter the finger gaps 136 between the bushing fingers 135, they can continue to flow along with coolant into the headstock cabinet 140, down the bar stock, to the bar feeder 141. Once the chips are in the finger gaps, they can also inflict wobble during cutting causing reduced tool life and corrupt surface finish of the part produced.

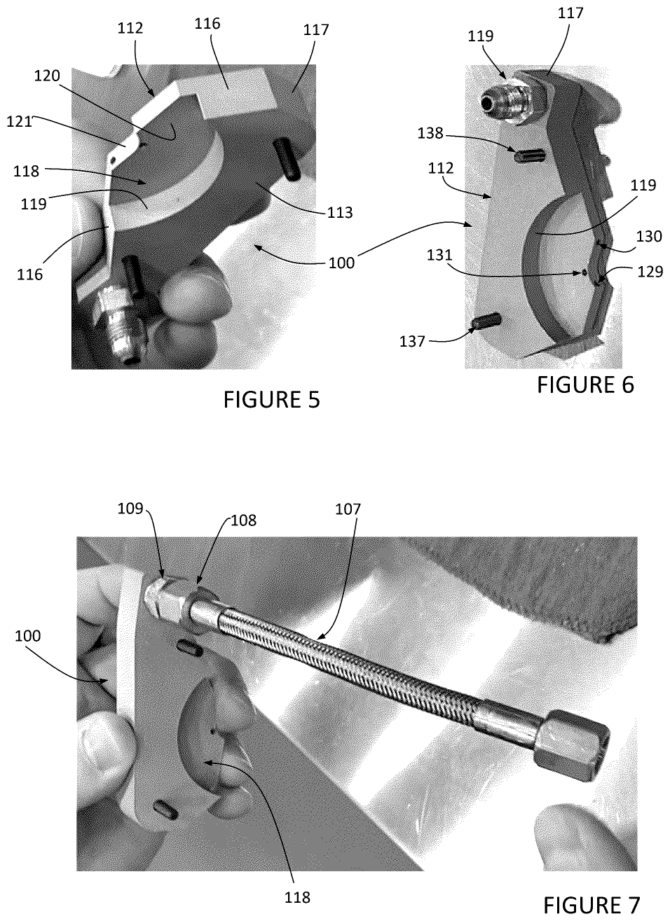

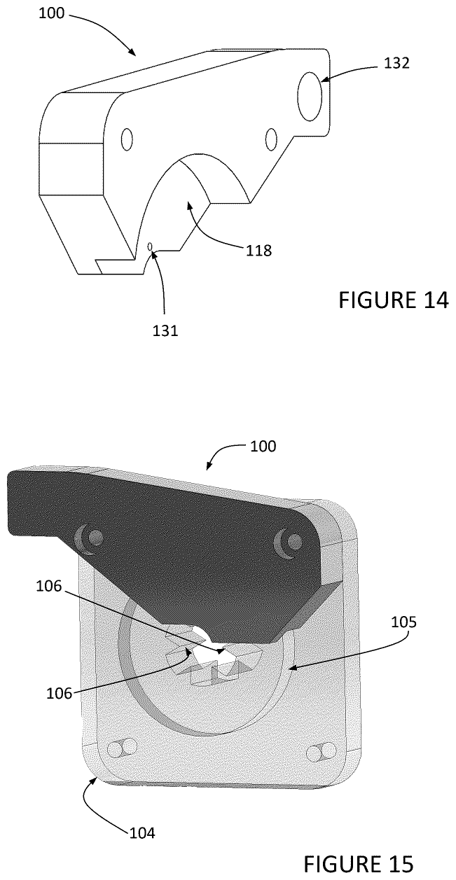

Depicted in FIGS. 5-15 is a preferred embodiment of a coolant delivery head 100 wherein the coolant delivery head is a one piece structure. Most CNC lathes have minimal clearance between the guide bushing 134 and whirling unit 104 consequently limiting the space in which a spray head can offer coolant. However, coolant delivery head 100 comprises a delivery head body 112 that is plate like and defined by a substantially flat proximal face 113 opposed to a substantially flat distal face 114. The plate like body is sufficiently narrow to fit in the space between the guide bushing and whirling unit.

Delivery head body 112 comprises an upper face 115 which faces upward and extends between proximal face 113 and distal face 114. A lower face 116 faces downward while also extending between proximal face 113 and distal face 114. A pair of opposed lateral faces 117 face lateral and again extend between proximal face 113 and distal face 114. Inset into proximal face 113 is a whirling recess 118 defined by blow face 120 and boundary face 119 which extends between blow face 120 and proximal face 113. In this case, whirling recess 118 has a profile configured to receive a portion of whirling unit 104. Arcing into lower face 116 is spray face 121 extending between blow face 120 and distal face 114.

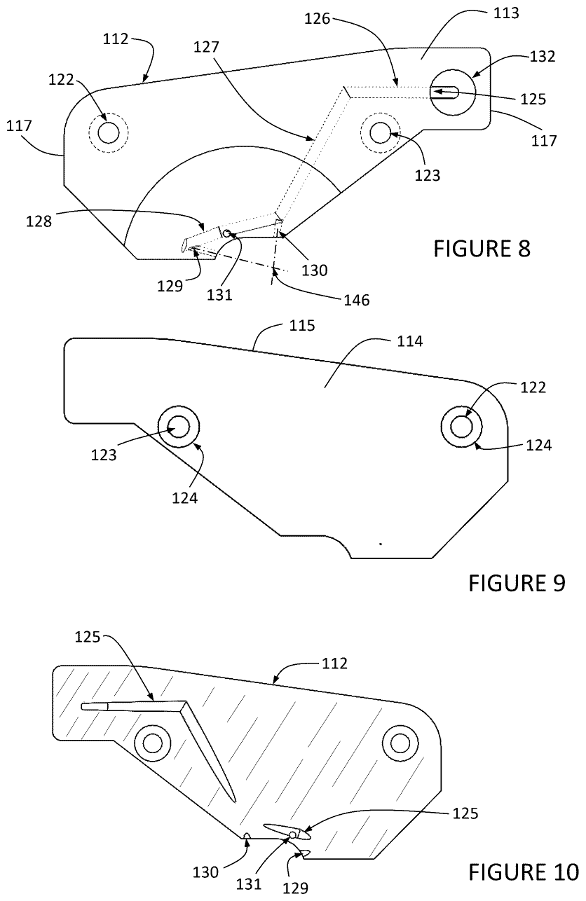

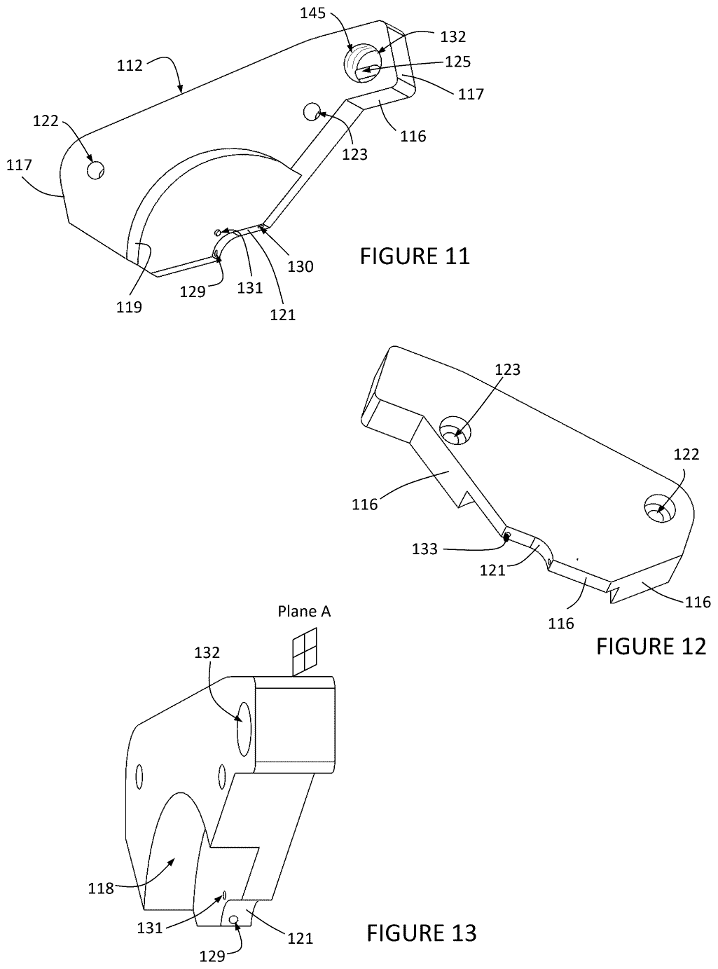

An intake port 132 (FIGS. 8, 11) extends into proximal face 113 for seating an intake fitting 109 to which a coolant supply line 107 is coupled, in this case, by use of a supply line coupler 108. For this purpose, intake port 132 can comprise threads 145. Meandering through delivery head body 112 is a coolant channel 125 for channeling coolant between intake port 132 and first delivery port 129, second delivery port 130, and blow port 131. Coolant channel 125 can take a smooth curving path through delivery head body 112, or as depicted here, coolant channel 125 can have a more distinctive first leg 126, second leg 127, and a third leg 128. In other embodiments, the path can be a combination of curves and straight leg. Traversing between coolant channel 125 and blow face 120 is blow port 131 which is used to blow coolant in a direction away from the guide bushing. Traversing between coolant channel 125 and spray face 121 is first delivery port 129 and second delivery port 130 which are directed at predetermined angles to deliver high pressure coolant during machining to the cutter insert and bar material intersection 146 from 2 different directions. Blow port 131 blows coolant straight backwards towards the sub-spindle thereby blowing the chip fragments in the direction of tailstock 142. This eliminates coolant from moving toward the guide bushing, and consequently eliminates movement of chip fragments into the guide bushing. Coolant supply line 107 connects from high pressure coolant supply 143 to supply the coolant delivery head 100.

Again, the delivery ports (first delivery port 129, second delivery port 130) and/or spray nozzles 133 of coolant delivery head 100 are positioned such that when secured by fasteners (first fastener 137, second fastener 138) to the whirling unit, the spray nozzles are aligned to spray at the insert cutting tips. Typically, visual obstructions limit one's ability to see if the spray is properly aligned. However, this self-aligning feature eliminates the random spraying of coolant that often happens when the spray direction is manually adjusted. In preferred embodiments, the coolant delivery head is made using additive manufacturing preferably from a metal or metal alloy although certain polymers could be utilized.

Extending between proximal face 113 and distal face 114 are at least one, but preferably two or more fastener holes. In this embodiment, first fastener hole 122 and second fastener hole 123 are spaced on delivery head body 112 for fastening with threaded holes on whirling unit 104. The holes can be counter sunk or counter bored 124 into the delivery head body 112 to conceal the head of respective first fastener 137 and second fastener 138 as they are used to secure and align coolant delivery head 100 to whirling unit 104.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A coolant delivery head for a turning machine having a whirling unit comprising:
a plate shaped delivery head body;
said delivery head body being one-piece;
an intake port in said delivery head body operable for receiving coolant;
coolant channels extending though said delivery head body from said intake port;
at least one said coolant channel terminating at a first delivery port;
at least one said coolant channel terminating at a second delivery port;
at least one said coolant channel terminating at a blow port; and,
wherein said first delivery port and said second delivery port are angled to direct coolant towards a cutting tip of a whirling unit cutter insert when used in said turning machine in an operational mode.

2. The coolant delivery head of claim 1 further comprising:
a spray face;
said spray face orientated generally parallel to the operational axis of a turning machine when in an operational mode.

3. The coolant delivery head of claim 1 further comprising:
a blow face;
said blow face orientated generally perpendicular to the operational axis of a turning machine when in an operational mode.

4. The coolant delivery head of claim 1 further comprising:
at least one fastener hole;
said delivery head body comprising a proximal face facing proximal in an operational mode;
said delivery head body comprising a distal face facing distally in an operational mode;
said at least one fastener hole extending between said proximal face and said distal face operable to seat a fastener for securing said delivery head body to a whirling unit.

5. The coolant delivery head of claim 4 wherein said fastener hole further comprises a countersunk or counter bored hole for concealing the head of a fastener.

6. The coolant delivery head of claim 1 wherein said coolant channels further comprise a first leg, a second leg, and a third leg.

7. The coolant delivery head of claim 1 wherein said first delivery port and said second delivery port spray coolant towards each other during operation.

8. The coolant delivery head of claim 1 wherein said blow port sprays coolant towards the tailstock of a turning machine.

9. The coolant delivery head of claim 1 further comprising:
coolant delivery head having a proximal facing proximal face in an operational mode; and,
wherein said intake port extends through said proximal face.

10. The coolant delivery head of claim 1 further comprising:
an intake fitting; and, wherein said intake fitting is seated in said intake port.

11. The coolant delivery head of claim 1 further comprising:
an intake fitting;
a coolant supply line; and,
wherein said intake fitting is threaded into said intake port and operable to couple with said coolant supply line.

12. The coolant delivery head of claim 1 further comprising:
a whirling head;
one or more fasteners;
said whirling head having threaded holes; and,
wherein said coolant delivery head is fastened to said threaded holes using said one or more fasteners.

13. The coolant delivery head of claim 12 wherein said fasteners are countersunk or counter bored in said coolant delivery head.

14. The coolant delivery head of claim 12 wherein said coolant delivery head is positioned above the whirling unit axis.

15. The coolant delivery head of claim 1 further comprising:
a CNC Swiss turning machine;
said CNC Swiss turning machine having a guide bushing;
said CNC Swiss turning machine having a whirling unit; and,
wherein said coolant delivery head has a width less than the distance between said guide bushing and said whirling unit.

16. The coolant delivery head of claim 11 wherein said coolant supply line is a braided stainless steel.

17. The coolant delivery head of claim 1 wherein said delivery head body is manufactured using additive manufacturing.

18. The coolant delivery head of claim 1 further comprising:
a whirling recess;
said whirling recess inset in said proximal face; and,
wherein said whirling recess is configured to receive a portion of a whirling unit therein when in an operational mode.
